(19) United States
(12) Patent Application Publication
(10) Pub. No.: US 2010/0074740 A1
(43) Pub. Date: Mar. 25, 2010

(54) VANE RING, AND METHOD FOR THE PRODUCTION THEREOF

(75) Inventors: Siegfried Sikorski, Munich (DE); Max Kraus, Munich (DE); Karl Hoffmann, Munich (DE); Alois Niedersüss, Munich (DE)

Correspondence Address: HOWISON & ARNOTT, L.L.P, P.O. BOX 741715, DALLAS, TX, 75374-1715, US

(73) Assignee: MTU AERO ENGINES, GMBH, Munich (DE)

(21) Appl. No.: 12/517,252

(22) PCT Filed: Dec. 1, 2007
(86) PCT No.: PCT/DE07/02169

§ 371 Date: Dec. 9, 2009

(30) Foreign Application Priority Data
Dec. 8, 2006 (DE) 10 2006 057 912.7

(51) Int. Cl. F01D 9/04; B23P 11/00

(52) U.S. Cl. 415/200; 415/208.2; 29/889.22

(57) ABSTRACT

The invention relates to a vane ring of a turbo engine, particularly a gas turbine, comprising a vane support ring and several guide vanes that are mounted on the vane support ring. According to the invention, the vane support ring and the guide vanes are made of different materials, the materials of which the guide vanes are made being of a higher quality than the material of which the vane support ring is made.

### CROSS-REFERENCE TO RELATED APPLICATIONS

This application is a U.S. National Phase application submitted under 35 U.S.C. §371 of Patent Cooperation Treaty application serial no. PCT/DE2007/002169, filed Dec. 1, 2007, and entitled VANE RING, AND METHOD FOR THE PRODUCTION THEREOF, which application claims priority to German patent application serial no. DE 10 2006 057 912.7, filed Dec. 8, 2006, and entitled LEITSCHAUFELKRANZ SOWIE VERFAHREN ZUM HERSTELLEN DESSELBEN, the specifications of which are incorporated herein by reference in their entireties.

### TECHNICAL FIELD

The invention relates to a guide vane ring of a turbo engine, particularly to a gas turbine. In addition, the invention relates to a procedure for manufacturing a guide vane ring as well as a procedure for manufacturing guide vanes for a guide vane ring.

### BACKGROUND

Modern gas turbines, especially aircraft engines, must cope with high demands in regard to reliability, weight, performance, cost effectiveness and service life. In recent decades, aircraft engines have especially been developed in the civil-aviation sector, which fully cope with the above requirements and have achieved a high degree of technical perfection. In development of aircraft engines, among other things, choices of materials, searches for new suitable materials, and searches for new manufacturing procedures are playing a decisive role.

The most important materials currently used for aircraft engines or other gas turbines are titanium alloys, nickel alloys (also called superalloys) and high strength steels. The high-strength steels are used for shaft parts, transmission parts, compressor housings and turbine housings. Titanium alloys are typical materials for compressor housings. Nickel alloys are suited for the hot parts of the aircraft engine.

Investment casting and forging are in the first rank from the state of the art as production procedures for gas turbine components of titanium alloys, nickel alloys or other alloys. All highly stressed gas turbine components, such as components for a compressor, are forged parts. In contrast, components for a turbine are as a rule made as investment-cast parts.

Powder-metallurgical injection molding represents an interesting alternative for production or manufacture of complex components. Powder-metallurgical injection molding is related to plastic injection molding and also is designated as metal form spraying or the metal injection molding (MIM) procedure. Using powder-metallurgical injection molding, components can be manufactured that attain almost the full thickness as well as roughly the static stability of forged parts. The usual reduction in dynamic stability compared to forged parts can be compensated for by suitable choices of materials.

In the area of the compressor as well as in the area of the turbine, gas turbines make use of guide vane rings on the stator side, with a guide vane ring comprising multiple guide vanes that are attached on a guide vane carrier ring. With this, the guide vanes are typically soldered to the guide vane carrier ring. With guide vane rings known from the state of the art, the guide vanes and the guide vane carrier ring are produced from an identical material.

Based on this, the problem that is the basis for the present invention is to create a novel guide vane ring and a procedure to manufacture same.

### SUMMARY

This problem is solved by a guide vane ring of a turbomachine, especially a gas turbine, with a guide vane carrier ring and multiple guide vanes attached on the guide vane carrier ring, characterized in that the guide vane carrier ring and the guide vanes are produced from differing materials, with the material from which the guide vane are produced being of higher value than the material from which the guide vane carrier ring is produced. According to the invention, the guide vane carrier ring and the guide vanes are produced from different materials, with the material from which the guide vanes are produced being of higher value than the material from which the guide vane carrier ring is produced.

In accordance with the present invention, it is proposed to manufacture the guide vane carrier ring and the guide vanes from differing materials, with the material of the guide vanes being of higher value than the material of the guide vane carrier ring. By this means it is possible to make available a guide vane ring that is optimally adapted to the thermal as well as the mechanical requirements, with simultaneous optimization of costs.

Preferably the guide vane carrier ring and the guide vanes are manufactured from a nickel-based alloy, whereby the nickel-based alloy from which the guide vanes are produced is more thermally stable than the nickel-base alloy from which the guide vane carrier ring is produced.

The invention-specific procedure for manufacturing a guide vane ring is defined the following steps: (a) manufacturing of a guide vane carrier ring from a first material; (b) manufacturing of guide vanes from a second material that is of higher value than the first material; and (c) soldering the guide vanes with the guide vane carrier ring. A procedure for manufacture of guide vanes for a guide vane ring is defined in the following steps: (a) individual or multiple continuous guide vanes are produced as a blank by powder-metallurgical injection molding; (b) then the guide vane blanks produced by powder-metallurgical injection molding are processed by a precise electrochemical machining (PECM) process or by electrochemical machining (ECM).

### BRIEF DESCRIPTION OF THE DRAWINGS

Preferred further embodiments of the invention can be gleaned from the subordinate claims and the following specification. Embodiment examples of the invention are explained in greater detail using the drawings without being limited to them. Shown are:

FIG. 1 multiple jointly manufactured guide vane blanks

FIG. 2 likewise multiple jointly manufactured guide vane blanks

### DETAILED DESCRIPTION

The present invention relates to a guide vane ring of a turbomachine, especially a gas turbine embodied as an aircraft engine. Such a guide vane ring has multiple guide vanes that are attached to a guide vane carrier ring.

In accordance with the present invention, it is proposed to manufacture the guide vane carrier ring and the guide vanes from differing materials. The guide vane carrier ring is produced from a first material, the guide vanes are produced from a second material, with the material from which the guide vanes are produced being of higher value than the material from which the guide vane carrier ring is produced. By a higher-value material, it is to be especially understood that it has a higher thermal stability, and therefore is more thermally stable.

In a preferred embodiment form of the invention, the guide vane carrier ring of the guide vane ring is manufactured from the nickel-based alloy Inconel® alloy 718 (IN 718) by the Special Metals Corporation. The guide vanes are manufactured from a higher-value or more thermally stable nickel-based alloy, namely from the nickel-based alloy UDIMET® alloy 720 (U720) by the Special Metals Corporation. With this, the guide vanes are soldered to the guide vane carrier ring.

For manufacture of an invention-specific guide vane ring, the procedure is that the guide vane carrier ring is produced from the first material, especially the nickel-based alloy Inconel® alloy 718, particularly by forging. The guide vanes are produced from the second material, especially from UDIMET® alloy 720, preferably by powder-metallurgical injection molding.

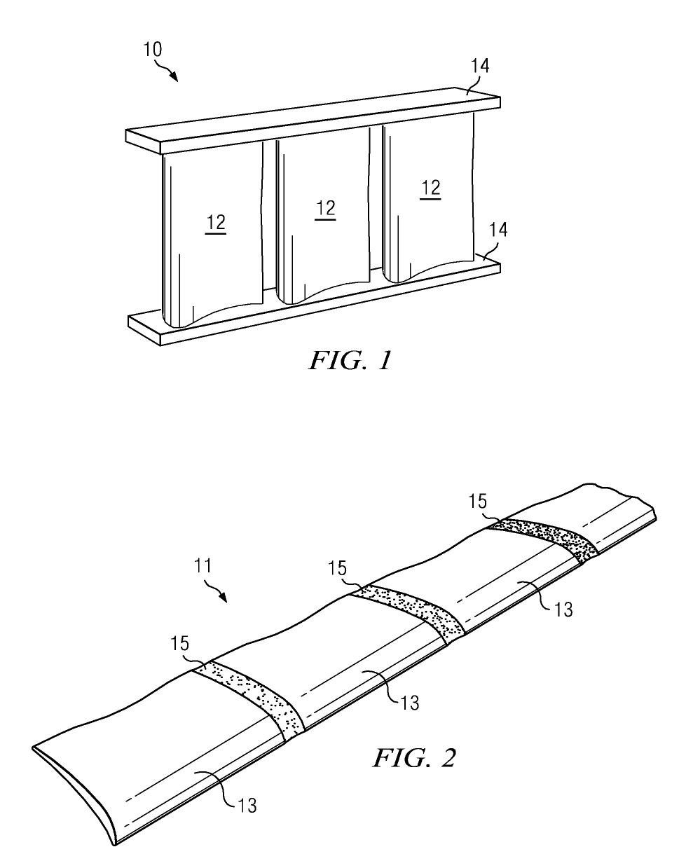

When manufacturing the guide vanes via powder-metallurgical injection molding, multiple guide vanes are produced as a continuous blank, so that accordingly, simultaneously multiple guide vane blanks are produced via powder-metallurgical injection molding. FIGS. 1 and 2 each shows such blanks 10, 11 of multiple guide vane blanks 12 and 13, produced via powder-metallurgical injection molding.

In FIG. 1, in blank 10, the guide vane blanks 12 are lined up axially behind each other, and are connected with each other by crosspieces 14 in the area of the guide vane tips and the guide vane feet.

In FIG. 2, the guide vane blanks 13 in blank 11 are stacked one over the other in the radial direction of same, so that accordingly, via joining pieces 15, adjoining guide vane blanks 13 are connected so that a guide vane tip of one guide vane blank 13 is connected with the guide vane foot of the adjoining guide vane blank 13 via a joining piece 15.

As explained above, accordingly multiple guide vanes for a guide vane ring are produced via powder-metallurgical injection molding as a continuous blank. Powder-metallurgical injection molding is also designated as metal injection molding (MIM).

After multiple guide vanes have been manufactured as a continuous blank by powder-metallurgical injection molding, the guide vane blanks produced by powder-metallurgical injection molding are processed by milling or grinding or an electrochemical machining (ECM) process. Preferably the guide vane blanks are processed by a precise electrochemical machining (PECM) process.

Following this, the guide vanes that preferably are manufactured by a combined MIM process and PECM process are inserted into the guide vane carrier ring and soldered to same, with the guide vane ring thus manufactured being then subjected to heat treatment, to ensure optimal stability for the guide vane ring.

1-11. (canceled)

12. A guide vane ring of a turbo engine, the guide vane ring comprising:
a guide vane carrier ring produced from a first material; and
a plurality of guide vanes attached to the guide vane carrier ring, each of the plurality of guide vanes produced from a second material that is different from the first material;
wherein with the second material from which the guide vanes are produced has a higher value of thermal stability than the first material from which the guide vane carrier ring is produced.

13. A guide vane ring according to claim 12, wherein the guide vanes are soldered to the guide vane carrier ring.

14. A guide vane ring according to claim 12, wherein the guide vane carrier ring and the guide vanes are both manufactured from a nickel-based alloy, with the nickel-based alloy from which the guide vanes are produced being more thermally stable than the nickel-based alloy from which the guide vane carrier ring is produced.

15. A guide vane ring according to claim 14, wherein:
the guide vane carrier ring is produced from the nickel-based alloy Inconel ® alloy 718; and
the guide vanes are produced from the nickel-based alloy UDIMET ® alloy 720.

16. A method for manufacturing a guide vane ring of a turbo engine, the method comprising the following steps:
a) manufacturing a guide vane carrier ring from a first material;
b) manufacturing a plurality of guide vanes from a second material that is of higher value of thermal stability than the first material; and
c) soldering the guide vanes to the guide vane carrier ring.

17. A method according to claim 16, wherein multiple guide vanes of the plurality of guide vanes are produced by powder-metallurgical injection molding as a continuous blank.

18. A method according to claim 17, wherein the guide vane blanks produced by powder-metallurgical injection molding are processed, before attachment of the guide vanes on the guide vane carrier ring, by one of (a) an electrochemical machining (ECM) process, (b) milling and (c) grinding.

19. A method according to claim 18, wherein the guide vane blanks produced by powder-metallurgical injection molding are, before attachment of the guide vanes on the guide vane carrier ring, processed by an electrochemical machining (ECM) process.

20. A method according to claim 16, wherein after attachment of the guide vanes on the guide vane carrier ring, the guide vane ring thus produced is subjected to a heat treatment.

21. A method according to claim 16, wherein the guide vane carrier ring is produced by forging.

22. A method for manufacturing guide vanes for a guide vane ring of a turbo engine, the method comprising the following steps:
(a) producing a plurality of continuously connected guide vane blanks by powder-metallurgical injection molding;
(b) processing the guide vane blanks by one of a precise electrochemical machining (PECM) process and an electrochemical machining (ECM) process.

23. A method according to claim 22, wherein:
each of the guide vane blanks of the plurality of continuously connected guide vane blanks includes a tip portion and a root portion defining a radial axis therebetween;
the guide vane blanks are oriented on the plurality of continuously connected guide vane blanks with their radial axes aligned; and
the tip portion of one guide vane blank is connected to the foot portion of an adjacent guide vane blank via a joining piece.

24. A method according to claim 22, wherein:
each of the guide vane blanks of the plurality of continuously connected guide vane blanks includes a tip portion and a root portion defining a radial axis therebetween;
the guide vane blanks are disposed on the plurality of continuously connected guide vane blanks with their radial axes parallel to one another;
the tip portions of one guide vane blank is connected to the tip portion of an adjacent guide vane blank via a first crosspiece; and
the foot portion of one guide vane blank is connected to the foot portion of an adjacent guide vane blank via a second crosspiece.
